(19) United States
(12) Patent Application Publication
(10) Pub. No.: US 2026/0332342 A1
(43) Pub. Date: Oct. 22, 2026

(54) ACQUISITION OF TARGET CELL CHANNEL STATE INFORMATION

(71) Applicant: QUALCOMM Incorporated, San Diego, CA (US)

(72) Inventors: Navid ABEDINI, Basking Ridge, NJ (US); Tao LUO, San Diego, CA (US); Junyi LI, Greentown, PA (US); Xiaoxia ZHANG, San Diego, CA (US); Jelena DAMNJANOVIC, Del Mar, CA (US)

(21) Appl. No.: 19/183,254

(22) Filed: Apr. 18, 2025

(51) Int. Cl. H04L 5/00; H04W 48/16; H04W 74/0833

(52) U.S. Cl. CPC H04L 5/0051; H04W 48/16; H04W 74/0833

(57) ABSTRACT

Various aspects of the present disclosure generally relate to wireless communication. In some aspects, a user equipment (UE) may receive information associated with transmitting a request, wherein the request is configured to trigger, on a target cell, activation of a channel state information reference signal (CSI-RS), an interference measurement resource (IMR), a sounding reference signal (SRS), or a combination thereof. The UE may transmit the request to a network node associated with the target cell, wherein the request is generated based at least in part on the information associated with transmitting the request. Numerous other aspects are described.

### FIELD OF THE DISCLOSURE

Aspects of the present disclosure generally relate to wireless communication and specifically relate to techniques, apparatuses, and methods associated with acquisition of target cell channel cell information.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In wireless communication systems, mobility of a user equipment (UE) between cells is used for maintaining connectivity and data transmission rates. In some wireless communication systems, a lower-layer triggered mobility (LTM) framework may be used for maintaining connectivity and data transmission rates for UEs. In some cases, an LTM framework may facilitate the acquisition of timing and channel state information, enabling handovers between a serving cell (e.g., a cell that is currently serving a UE) and a target cell (e.g., a cell that will be serving the UE upon completion of a handover procedure).

### SUMMARY

Some aspects described herein relate to a method of wireless communication performed by a user equipment (UE). The method may include receiving information associated with transmitting a request, wherein the request is configured to trigger, on a target cell, activation of a channel state information reference signal (CSI-RS), an interference measurement resource (IMR), a sounding reference signal (SRS), or a combination thereof. The method may include transmitting the request to a network node associated with the target cell, wherein the request is generated based at least in part on the information associated with transmitting the request.

Some aspects described herein relate to a method of wireless communication performed by a network node. The method may include transmitting, to a UE, information associated with transmitting a request, wherein the request is configured to trigger, on a target cell, activation of a CSI-RS, an IMR, an SRS, or a combination thereof. The method may include receiving information associated with the activation of the CSI-RS, the IMR, or the SRS.

Some aspects described herein relate to a non-transitory computer-readable medium that stores a set of instructions for wireless communication by a UE. The set of instructions, when executed by one or more processors of the UE, may cause the UE to receive information associated with transmitting a request, wherein the request is configured to trigger, on a target cell, activation of a CSI-RS, an IMR, an SRS, or a combination thereof. The set of instructions, when executed by one or more processors of the UE, may cause the UE to transmit the request to a network node associated with the target cell, wherein the request is generated based at least in part on the information associated with transmitting the request.

Some aspects described herein relate to a non-transitory computer-readable medium that stores a set of instructions for wireless communication by a network node. The set of instructions, when executed by one or more processors of the network node, may cause the network node to transmit, to a UE, information associated with transmitting a request, wherein the request is configured to trigger, on a target cell, activation of a CSI-RS, an IMR, an SRS, or a combination thereof. The set of instructions, when executed by one or more processors of the network node, may cause the network node to receive information associated with the activation of the CSI-RS, the IMR, or the SRS.

Some aspects described herein relate to a UE. The UE may include a processing system. The processing system may include one or more processors and one or more code-storing memories coupled with the one or more processors. The processing system may be configured to cause the UE to receive information associated with transmitting a request wherein the request is configured to trigger, on a target cell, activation of a CSI-RS, an IMR, an SRS, or a combination thereof. The processing system may be configured to cause the UE to transmit the request to a network node associated with the target cell, wherein the request is generated based at least in part on the information associated with transmitting the request.

Some aspects described herein relate to a network node. The network node may include a processing system. The processing system may include one or more processors and one or more code-storing memories coupled with the one or more processors. The processing system may be configured to cause the network node to transmit, to a UE, information associated with transmitting a request, wherein the request is configured to trigger, on a target cell, activation of a CSI-RS, an IMR, an SRS, or a combination thereof. The processing system may be configured to cause the network node to receive information associated with the activation of the CSI-RS, the IMR, or the SRS.

Some aspects described herein relate to an apparatus for wireless communication. The apparatus may include means for receiving information associated with transmitting a request, wherein the request is configured to trigger, on a target cell, activation of a CSI-RS, an IMR, an SRS, or a combination thereof. The apparatus may include means for transmitting the request to a network node associated with the target cell, wherein the request is generated based at least in part on the information associated with transmitting the request.

Some aspects described herein relate to an apparatus for wireless communication. The apparatus may include means for transmitting, to a UE, information associated with transmitting a request, wherein the request is configured to trigger, on a target cell, activation of a CSI-RS, an IMR, an SRS, or a combination thereof. The apparatus may include means for receiving information associated with the activation of the CSI-RS, the IMR, or the SRS.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIGS. 2 and 3 are diagrams illustrating examples of Layer 1/Layer 2 (L1/L2) inter-cell mobility.

FIG. 4 is a diagram illustrating an example of an L1/L2 triggered mobility procedure.

FIG. 5 is a diagram of an example associated with acquisition of target cell channel state information.

FIG. 6 is a diagram illustrating an example process performed, for example, at a user equipment or an apparatus of a user equipment.

FIG. 7 is a diagram illustrating an example process performed, for example, at a network node or an apparatus of a network node.

FIG. 8 is a diagram of an example apparatus for wireless communication.

FIG. 9 is a diagram of an example apparatus for wireless communication.

### DETAILED DESCRIPTION

In wireless communication systems, mobility of a user equipment (UE) between cells is used for maintaining connectivity and data transmission rates. In some wireless communication systems, a lower-layer triggered mobility (LTM) framework may be used for maintaining connectivity and data transmission rates for UEs. In some cases, an LTM framework may facilitate the acquisition of timing and channel state information, enabling handovers between a serving cell (e.g., a cell that is currently serving a UE) and a target cell (e.g., a cell that will be serving the UE upon completion of a handover procedure). The LTM framework supports procedures for acquiring basic channel and timing information, such as reference signal received power (RSRP) level information that can be acquired from synchronization signal blocks (SSBs) transmitted by the target cell and uplink timing information that can be acquired by performing an early random access channel (RACH) procedure with the target cell. This basic channel and timing information may be acquired prior to performing a handover and may be used to determine that a handover procedure should be performed. However, it may be beneficial to also obtain channel quality information associated with the target cell prior to making a handover decision.

Various aspects relate generally to extending the LTM framework to enable a UE to acquire channel quality information associated with a target cell prior to making a handover decision. Some aspects more specifically relate to providing (e.g., by a serving cell) a UE with information associated with a set of resources (e.g., channel state information reference signal (CSI-RS) resources, interference measurement resources (IMRs), or sounding reference signal (SRS) resources) and configurations (e.g., a quantity of ports, a bandwidth, a density in time and frequency domains, quasi co-location (QCL) information, or a scrambling identifier, among other examples) associated with one or more target cells.

In some aspects, the UE may be provided with configuration information related to requesting activation of a set of resources and a configuration. In some aspects, the request may be associated with obtaining uplink timing information (e.g., a timing advance), communication of a CSI-RS, activation or allocation of IMRs, communication of an SRS, or a combination thereof. In some aspects, the configuration information may indicate resources via which the request is to be transmitted. In some aspects, the configuration information may indicate a configuration or format of the request. In some aspects, the configuration information may include information associated with a response to the request (e.g., whether a response will be transmitted to the UE by the target cell) or information associated with a window during which the resources are to be activated (e.g., a time offset from a transmission of the request or from a reception of a response to the request).

Particular aspects of the subject matter described in this disclosure can be implemented to realize one or more of the following potential advantages. In some examples, the described techniques can be used to enable early acquisition of channel quality information associated with a target cell. The early acquisition of channel quality information can improve the selection of the target cell for mobility by enabling a UE to identify a target cell that can provide an increased throughput or a more energy-efficient data rate relative to a current serving cell of the UE. The early acquisition of channel quality information can decrease an amount of time required for the UE to being performing high data rate communication with the target cell (e.g., immediately after moving to the target cell).

In some aspects, the request for activation of the set of resources and configurations may enable network energy savings. In some aspects, a target cell may transmit or receive a reference signal based at least in part on receiving a request from a UE (e.g., rather than periodically transmitting or monitoring for a reference signal), which may reduce an amount of energy utilized by the target cell.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

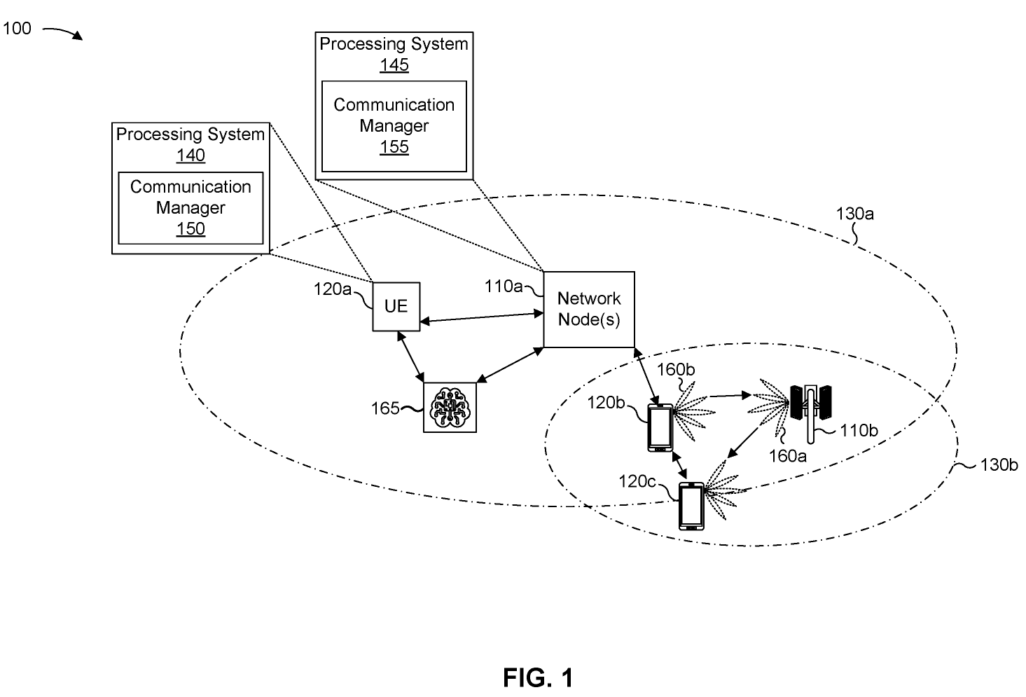

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

One enhancement for multi-beam operation at higher carrier frequencies is facilitation of efficient (for example, low latency and low overhead) downlink or uplink beam management operations to support Layer 1 or Layer 2 (L1/L2)-centric inter-cell mobility. L1/L2 signaling may be referred to as “lower layer” signaling. L1/L2 signaling may be used to activate or deactivate candidate cells in a set of cells configured for lower layer triggered mobility (LTM) or to provide reference signals for measurement by the UE 120, by which the UE 120 may select a candidate beam as a target beam for a lower layer handover operation. Accordingly, L1/L2-centric inter-cell mobility may enable a UE 120 to perform a cell switch via dynamic control signaling at lower layers (for example, DCI for L1 signaling or a MAC-CE for L2 signaling), rather than semi-static Layer 3 (L3) RRC signaling. Thus, L1/L2 centric inter-cell mobility may reduce latency, reduce overhead, or otherwise increase efficiency of the cell switch.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

Network energy saving (NES) or network energy efficiency measures are expected to have increased importance in wireless network operations for various reasons, such as climate change mitigation, environmental sustainability, or network cost reduction, among other examples. For example, although NR generally offers a significant energy efficiency improvement per gigabyte over previous generations (for example, LTE), new NR use cases or the adoption of millimeter wave frequencies may require more network sites, more network antennas, larger bandwidths, or more frequency bands, among other examples which may lead to more efficient wireless networks that nonetheless have higher energy requirements or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption or energy costs are associated with a RAN, which accounts for about half of the energy consumption in a wireless network, with data centers and fiber transport accounting for smaller shares. Accordingly, measures to increase network energy savings or improve network energy efficiency are factors that may drive adoption or expansion of wireless networks.

In some examples, a UE 120 or network node 110 may implement power saving features (also referred to as energy saving features). Power saving features may include, for example, relaxed radio resource monitoring (such as relaxed reference signal monitoring for devices operating in low mobility or in good radio conditions), DRX operation, reduced PDCCH monitoring during DRX active times, on-demand system information transmission, on-demand SSB transmission, antenna port adaptation, advanced CSI reporting, or power-efficient paging reception.

In some examples, a UE 120 may operate in association with a DRX configuration (for example, indicated to the UE 120 by a network node 110). DRX operation may enable the UE 120 to enter a sleep mode or state at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state. A DRX cycle may also include one or more durations during which the UE 120 may operate in an inactive state. The one or more durations in which the UE 120 may operate in an inactive state may be opportunities for the UE 120 to enter a DRX sleep mode in which the UE 120 may refrain from monitoring for communications from a network node 110. Additionally or alternatively, the UE 120 may deactivate one or more antennas, RF chains, or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect or does not successfully decode any downlink communications during the DRX on duration, the UE 120 may enter a DRX sleep mode for the inactive time duration at the end of the DRX on duration. If the UE 120 detects or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

In some examples, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, or spatial resources) may be shared between access links and backhaul links.

An anchor network node 110 may include a CU, which may perform access node controller (ANC) functions or AMF functions. The CU may configure a DU of the anchor network node 110 or may configure one or more non-anchor network nodes 110 (for example, a mobile termination (MT) function or a DU function of each of the IAB nodes) that connect to the core network via the anchor network node 110. Thus, a CU of an anchor network node 110 may control or configure the entire IAB network (or a portion thereof) that connects to the core network via the anchor network node 110, such as by using control messages or configuration messages (for example, an RRC configuration message or an F1 application protocol (F1AP) message).

A non-anchor network node 110 other than an anchor network node also may control or schedule communications for a second IAB node (for example, when the non-anchor network node provides DU functions for the MT functions of the second IAB node). In such deployments, the first non-anchor network node 110 may be referred to as a parent IAB node of the second non-anchor network node 110, and the second non-anchor network node 110 may be referred to as a child IAB node of the first non-anchor network node 110. Similarly, a child IAB node of the second non-anchor network node 110 may be referred to as a grandchild IAB node of the first non-anchor network node 110. A DU function of a parent IAB node may control or schedule communications for child IAB nodes of the parent IAB node. In some examples, a DU function may exercise limited control over communications of a grandchild node, such as via indication of soft resources or restricted beams at a child node associated with the grandchild node. In some examples, a non-anchor network node 110 that implements a DU function may be referred to as a scheduling node or a scheduling component, and a non-anchor network node 110 that implements an MT function may be referred to as a scheduled node or a scheduled component.

In some aspects, a UE 120 may include a communication manager 150. As described in more detail elsewhere herein, the communication manager 150 may receive information associated with transmitting a request, wherein the request is configured to trigger, on a target cell, activation of a CSI-RS, an IMR, an SRS, or a combination thereof; and transmit the request to a network node associated with the target cell, wherein the request is generated based at least in part on the information associated with transmitting the request. Additionally, or alternatively, the communication manager 150 may perform one or more other operations described herein.

In some aspects, the network node 110 may include a communication manager 155. As described in more detail elsewhere herein, the communication manager 155 may transmit, to a UE, information associated with transmitting a request, wherein the request is configured to trigger, on a target cell, activation of a CSI-RS, an IMR, an SRS, or a combination thereof; and receive information associated with the activation of the CSI-RS, the IMR, or the SRS. Additionally, or alternatively, the communication manager 155 may perform one or more other operations described herein.

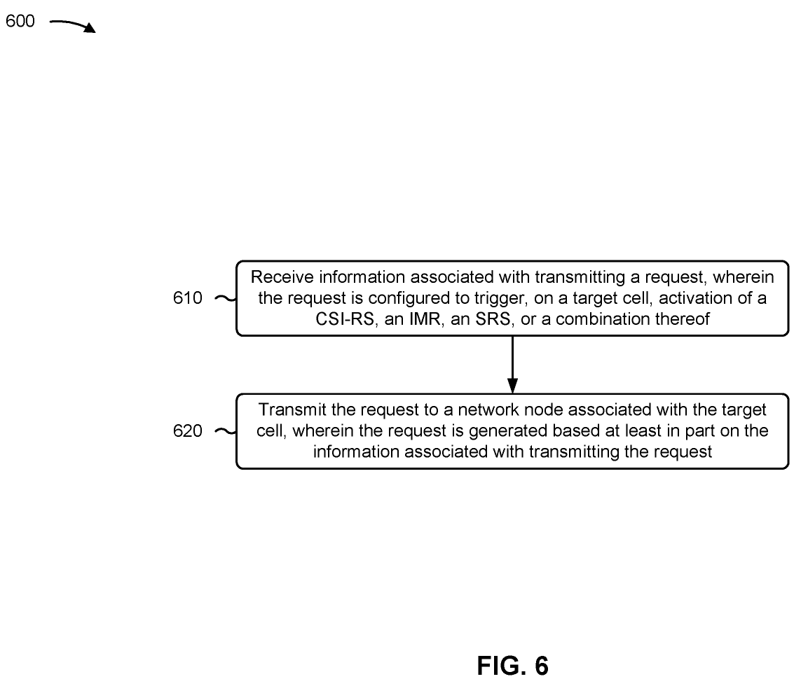

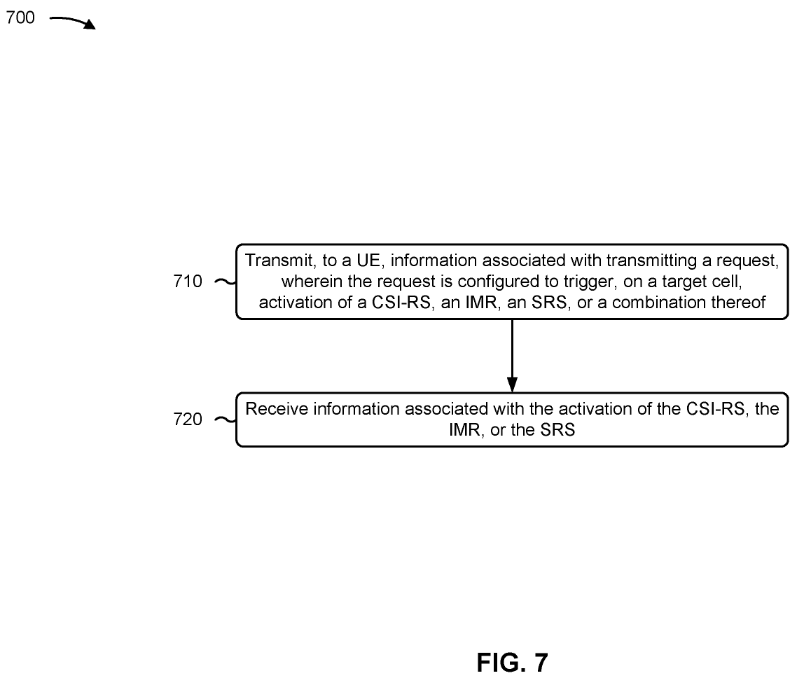

The network node 110, the processing system 145 of the network node 110, the UE 120, the processing system 140 of the UE 120, or any other component(s) of FIG. 1 may implement one or more techniques or perform one or more operations associated with acquisition of target cell CSI, as described in more detail elsewhere herein. For example, the processing system 145 of the network node 110, or the processing system 140 of the UE 120 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

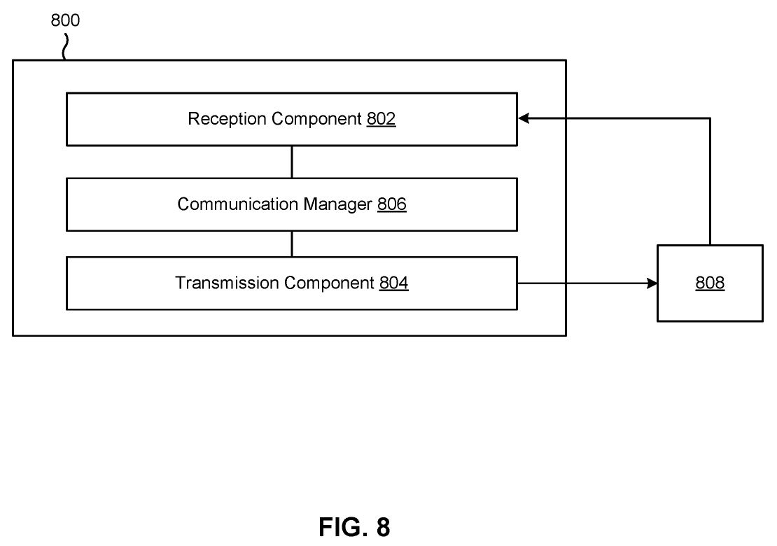

In some aspects, a UE includes means for receiving information associated with transmitting a request, wherein the request is configured to trigger, on a target cell, activation of a CSI-RS, an IMR, an SRS, or a combination thereof; or means for transmitting the request to a network node associated with the target cell, wherein the request is generated based at least in part on the information associated with transmitting the request. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

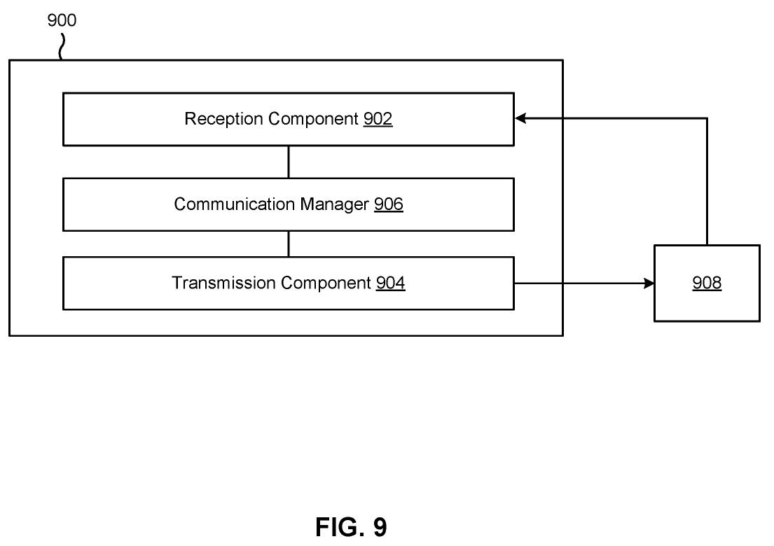

In some aspects, a network node includes means for transmitting, to a UE, information associated with transmitting a request, wherein the request is configured to trigger, on a target cell, activation of a CSI-RS, an IMR, an SRS, or a combination thereof; or means for receiving information associated with the activation of the CSI-RS, the IMR, or the SRS. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

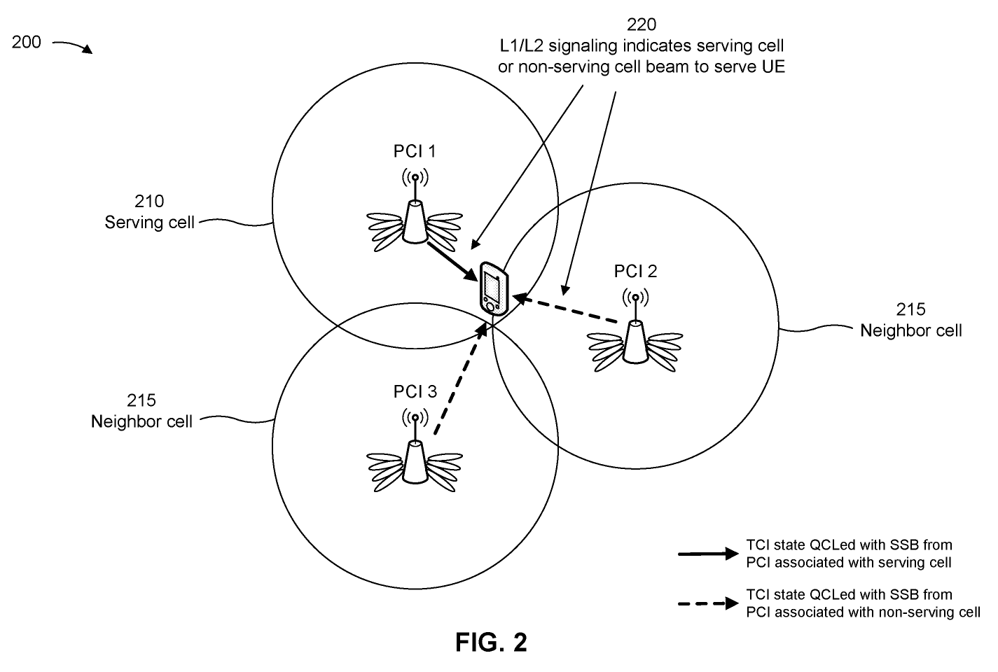

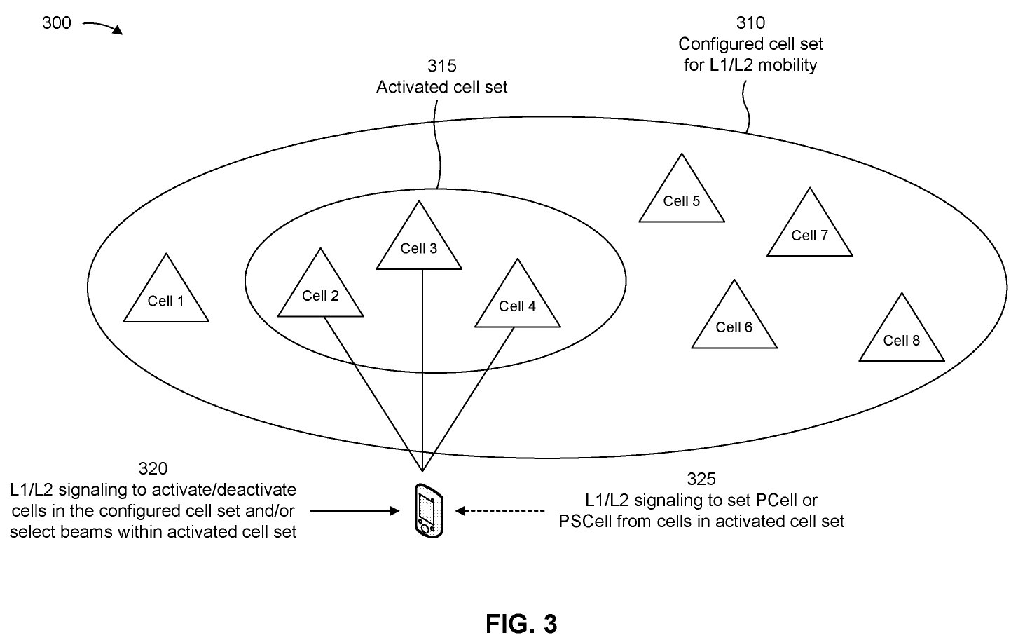

FIGS. 2 and 3 are diagrams illustrating examples 200 and 300 of L1/L2 inter-cell mobility.

In a wireless network, a UE and a network node may communicate on an access link using directional links (e.g., using high-dimensional phased arrays) to benefit from a beamforming gain or to maintain acceptable communication quality. The directional links, however, typically require fine alignment of transmit and receive beams, which may be achieved through a set of operations referred to as beam management or beam selection, among other examples. Further, a wireless network may support multi-beam operation at relatively high carrier frequencies (e.g., within FR2 or FR4), which may be associated with harsher propagation conditions than comparatively lower carrier frequencies. For example, relative to a sub-6 gigahertz (GHz) band (e.g., FR1), signals propagating in a millimeter wave frequency band may suffer from increased pathloss and severe channel intermittency, or may be blocked by objects commonly present in an environment surrounding the UE (e.g., a building, a tree, or a body of a user, among other examples). Accordingly, beam management is particularly important for multi-beam operation in a relatively high carrier frequency.

One possible enhancement for multi-beam operation at higher carrier frequencies is facilitation of efficient (e.g., low latency and low overhead) downlink or uplink beam management to support higher L1/L2-centric inter-cell mobility. Accordingly, one goal for L1/L2-centric inter-cell mobility is to enable a UE to perform a cell switch via dynamic control signaling at lower layers (e.g., DCI for L1 signaling or a MAC CE for L2 signaling) rather than semi-static Layer 3 (L3) RRC signaling to reduce latency, reduce overhead, or otherwise increase efficiency of the cell switch.

For example, FIG. 2 illustrates an example 200 of a first L1/L2 inter-cell mobility technique, which may be referred to as beam-based inter-cell mobility, dynamic point selection based inter-cell mobility, or non-serving-cell-based inter-cell mobility, among other examples. As described in further detail herein, the first L1/L2 inter-cell mobility technique may enable a network node to use L1 signaling (e.g., DCI) or L2 signaling (e.g., a MAC CE) to indicate that a UE is to communicate on an access link using a beam from a serving cell or a non-serving cell. For example, in a wireless network where L1/L2 inter-cell mobility is not supported (e.g., cell switches are triggered only by an L3 handover), beam selection for control information and for data is typically limited to beams within a physical cell identity (PCI) associated with a serving cell. In contrast, in a wireless network that supports the first L1/L2 inter-cell mobility technique (e.g., as shown in FIG. 2), beam selection for control and data may be expanded to include any beams within a serving cell 210 or one or more non-serving neighbor cells 215 configured for L1/L2 inter-cell mobility.

For example, in the first L1/L2 inter-cell mobility technique shown in FIG. 2, a UE may be configured with a single serving cell 210, and may be further configured with a neighbor cell set that includes one or more non-serving cells 215 configured for L1/L2 inter-cell mobility. In general, the serving cell 210 and the non-serving cell(s) 215 configured for L1/L2 inter-cell mobility may be associated with a common CU and a common DU, or the serving cell 210 and the non-serving cell(s) 215 configured for L1/L2 inter-cell mobility may be associated with a common CU and different DUs. In some aspects, as shown by reference number 220, a network node may trigger L1/L2 inter-cell mobility for a UE using L1/L2 signaling (e.g., DCI or a MAC-CE) that indicates a TCI state quasi co-located (QCL’ed) with a reference signal (e.g., an SSB) associated with a PCI. For example, in FIG. 2, the UE may be communicating with the serving cell 210 using a TCI state that is QCL’ed with an SSB from a PCI associated with the serving cell 210 (e.g., shown as PCI 1 in FIG. 2), and L1/L2 signaling may trigger inter-cell mobility by indicating that the UE is to switch to communicating using a TCI state that is QCL’ed with an SSB from a PCI associated with a non-serving neighbor cell 215 (e.g., shown as PCI 2 in FIG. 2). Accordingly, in the first L1/L2 inter-cell mobility technique, the network node (e.g., the common CU controlling the serving cell 210 and the non-serving neighbor cell(s) 215) may use L1/L2 signaling to select a beam from either the serving cell 210 or a non-serving neighbor cell 215 to serve the UE.

In this way, relative to restricting L1/L2 beam selection to beams within the serving cell 210, the first L1/L2 inter-cell mobility technique may be more robust against blocking and may provide more opportunities for higher rank spatial division multiplexing across different cells. However, the first L1/L2 inter-cell mobility technique does not enable support for changing a special cell (SpCell) for a UE, where an SpCell may be a primary cell (PCell) or a primary secondary cell (PSCell). Rather, in the first L1/L2 inter-cell mobility technique, triggering an SpCell change is performed via a legacy L3 handover using RRC signaling. In this respect, the first L1/L2 inter-cell mobility technique is associated with a limitation in that L1/L2 signaling can only be used to indicate a beam from the serving cell 210 or a configured neighbor cell 215 while the UE is in the coverage area of the serving cell 210 (e.g., because L1/L2 signaling cannot be used to change the PCell or PSCell). Accordingly, FIG. 3 illustrates an example 300 of a second L1/L2 inter-cell mobility technique, which may be referred to as serving-cell-based inter-cell mobility, among other examples. As described in further detail herein, the second L1/L2 inter-cell mobility technique may enable a network node to use L1/L2 signaling (e.g., DCI or a MAC-CE) to indicate control information associated with an activated cell set or a deactivated cell set or to indicate a change to an SpCell within the activated cell set.

For example, as shown in FIG. 3, the second L1/L2 inter-cell mobility technique may use mechanisms that are generally similar to carrier aggregation to enable L1/L2 inter-cell mobility, except that different cells configured for L1/L2 inter-cell mobility may be on the same carrier frequency. As shown in FIG. 3, a network node may configure a cell set 310 for L1/L2 inter-cell mobility (e.g., using RRC signaling). As further shown, an activated cell set 315 may include one or more cells in the configured cell set 310 that are activated and ready to use for data or control transfer. Accordingly, in the second L1/L2 inter-cell mobility technique, a deactivated cell set may include one or more cells that are included in the cell set 310 configured for L1/L2 inter-cell mobility but are not included in the activated cell set 315. However, the cells that are included in the deactivated cell set can be readily activated, and thereby added to the activated cell set 315, using L1/L2 signaling. Accordingly, as shown by reference number 320, L1/L2 signaling can be used for mobility management of the activated cell set 315. For example, in some aspects, L1/L2 signaling can be used to activate cells within the configured cell set 310 (e.g., to add cells to the activated cell set 315), to deactivate cells in the activated cell set 315, or to select beams within the cells included in the activated cell set 315. In this way, the second L1/L2 inter-cell mobility technique may enable seamless mobility among the cells included in the activated cell set 315 using L1/L2 signaling (e.g., using beam management techniques).

Furthermore, as shown by reference number 325, the second L1/L2 inter-cell mobility technique enables using L1/L2 signaling to set or change an SpCell (e.g., a PCell or PSCell) from the cells included in the activated cell set 315. Additionally, or alternatively, when the cell to become the new SpCell is in the deactivated cell set (e.g., is included in the cell set 310 configured for L1/L2 mobility but not the activated cell set 315), L1/L2 signaling can be used to move the cell from the deactivated cell set to the activated cell set 315 before further L1/L2 signaling is used to set the cell as the new SpCell. However, in the second L1/L2 inter-cell mobility technique, an L3 handover (e.g., using RRC signaling) is used to change the SpCell when the new SpCell is not included in the cell set 310 configured for L1/L2 inter-cell mobility. In such cases, RRC signaling associated with the L3 handover may be used to update the cells included in the cell set 310 configured for L1/L2 inter-cell mobility. Accordingly, L1/L2 inter-cell mobility can provide more efficient cell switching to support multi-beam operation, enabling lower latency and reduced overhead by using L1 signaling (e.g., DCI) or L2 signaling (e.g., a MAC-CE) rather than L3 signaling (e.g., RRC) to change the beam(s) that a UE uses to communicate over an access link.

As indicated above, FIGS. 2 and 3 are provided as examples. Other examples may differ from what is described with regard to FIGS. 2 and 3.

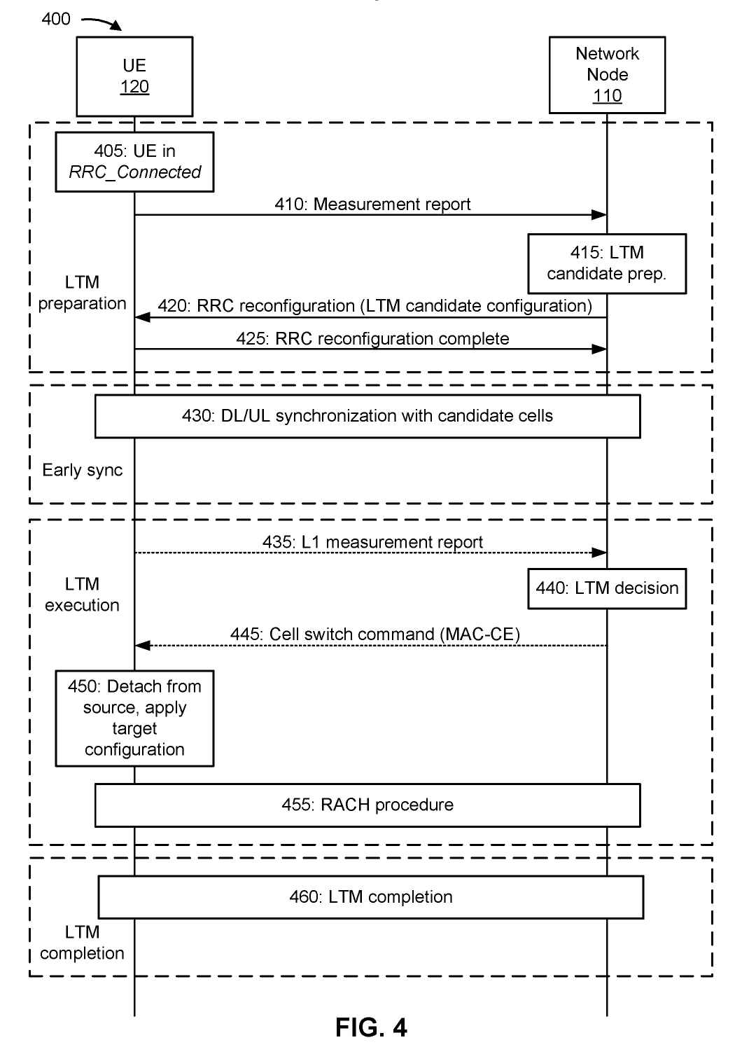

FIG. 4 is a diagram illustrating an example 400 of an L1/L2 triggered mobility (LTM) procedure.

In some examples, a network node 110 may instruct a UE 120 to change serving cells, such as when the UE 120 moves away from coverage of a current serving cell (sometimes referred to as a source cell) and toward coverage of a neighboring cell (sometimes referred to as a target cell). In some cases, the network node 110 may instruct the UE 120 to change cells using a layer 3 (L3) handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages or other L3 signaling and operations used to perform the handover procedures. Accordingly, in some examples, a UE 120 may be configured to perform a lower-layer (e.g., L1 or L2) handover procedure, sometimes referred to as an LTM procedure, such as the example 400 LTM procedure shown in FIG. 4. As shown in FIG. 4, the LTM procedure may include four phases: an LTM preparation phase, an early synchronization phase (shown as “early sync” in FIG. 4), an LTM execution phase, or an LTM completion phase.

During the LTM preparation phase, and as shown by reference number 405, the UE 120 may be in an RRC connected state (sometimes referred to as RRC_Connected) with a source cell. As shown by reference number 410, the UE 120 may transmit, and the network node 110 may receive, a measurement report (sometimes referred to as MeasurementReport), which may be an L3 measurement report. The measurement report may indicate signal strength measurements (e.g., RSRP, RSSI, RSRQ, or CQI) or similar measurements associated with the source cell or one or more neighboring cells. In some examples, based at least in part on the measurement report or other information, the network node 110 may decide to use LTM, and thus, as shown by reference number 415, the network node 110 may initiate LTM candidate preparation.

As shown by reference number 420, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE or cells for which the UE 120 may later be triggered to perform an LTM procedure. As shown by reference number 425, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as shown by reference number 430, the UE 120 may optionally perform downlink/uplink synchronization with the candidate cells associated with the one or more LTM candidate cell configurations. For example, the UE 120 may perform downlink synchronization and timing advance acquisition with the one or more candidate target cells prior to receiving an LTM switch command (which is described in more detail below in connection with reference number 445). In some aspects, performing the early synchronization with the one or more candidate cells may reduce latency associated with performing a RACH procedure later in the LTM procedure, which is described in more detail below in connection with reference number 455.

During the LTM execution phase, and as shown by reference number 435, the UE 120 may perform L1 measurements on the configured LTM candidate target cells, and thus may transmit, to the network node 110, lower-layer (e.g., L1) measurement reports. As shown by reference number 440, based at least in part on the lower-layer measurement reports, the network node 110 may decide to execute an LTM cell switch to a target cell. Accordingly, as shown by reference number 445, the network node 110 may transmit, and the UE 120 may receive, a MAC control element (MAC CE) or similar message triggering an LTM cell switch (the MAC CE or similar message is sometimes referred to herein as a cell switch command). The cell switch command may include an indication of a candidate configuration index associated with the target cell. As shown by reference number 450, based at least in part on receiving the cell switch command, the UE 120 may switch to the configuration of the LTM candidate target cell (e.g., the UE 120 may detach from the source cell and apply the target cell configuration). Moreover, as shown by reference number 455, the UE 120 may perform a RACH procedure toward the target cell, such as when a timing advance associated with the target cell is not available (e.g., in examples in which the UE 120 did not perform the early synchronization as described above in connection with reference number 430).

During the LTM completion phase, and as shown by reference number 460, the UE 120 may indicate successful completion of the LTM cell switch toward the target cell. In this way, a cell switch to a target cell may be performed using less overhead than for an L3 handover procedure, or a cell switch to a target cell may be associated with reduced latency as compared to L3 handover procedure.

As indicated above, FIG. 4 is provided as an example. Other examples may differ from what is described with respect to FIG. 4.

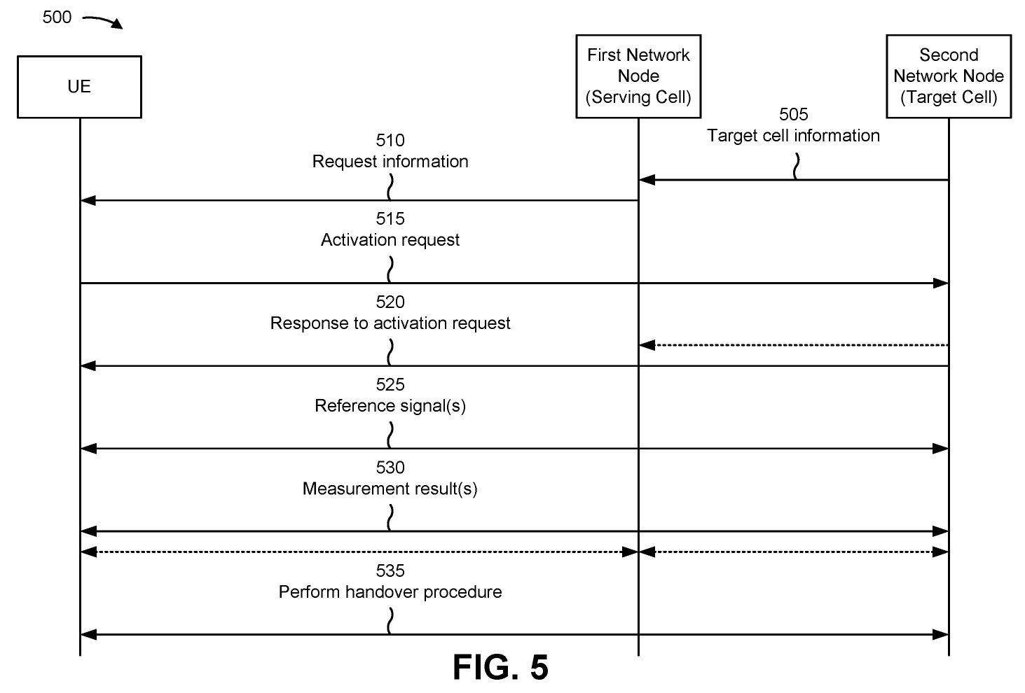

FIG. 5 is a diagram of an example 500 associated with acquisition of target cell CSI. As shown in FIG. 5, multiple network nodes may communicate with a UE (e.g., UE 120). The multiple network nodes may include one or more network nodes 110, one or more CUs, one or more DUs, one or more RUs, one or more core network nodes, one or more network servers, one or more application servers, or one or more access and mobility management functions (AMFs), among other examples. As shown in FIG. 5, example 500 includes a first network node associated with a serving cell of the UE and a second network node associated with a target cell. In some aspects, the UE and a first network node of the multiple network nodes may be part of a wireless communication network (e.g., wireless communication network 100). The UE and the first network node may have established a wireless connection prior to operations shown in FIG. 5.

As shown by reference number 505, the second network node may transmit target cell information to the first network node. In some aspects, the second network node may transmit the target cell information via a backhaul link. For example, the first network node and the second network node may be included in an IAB network and the second network node may transmit the target cell information to the first network node via Xn/F1 interfaces between two associated DUs/CUs.

In some aspects, the target cell information may indicate one or more sets of resources associated with the second network node. For example, the target cell information may indicate one or more sets of CSI-RS resources, IMR resources, or SRS resources, among other examples.

In some aspects, the target cell information may indicate a set of configurations associated with the second network node or the target cell. For example, the target cell information may indicate a quantity of ports associated with the second network node, a bandwidth associated with the second network node or the target cell, a density in time and frequency domains, QCL information, or a scrambling identifier associated with the second network node, among other examples.

In some aspects, the target cell configuration information may include information associated with a set of reference signals. For example, the target cell configuration information may indicate a set of reference signals that are periodically transmitted by the second network node, a periodicity at which the set of reference signals are transmitted, a set of periodicities at which the set of reference signals can be transmitted (e.g., based at least in part on receiving a request to modify the periodicity at which the set of reference signals are currently being transmitted), or a set of on-demand reference signals (e.g., a set of reference signals that are transmitted or monitored for based at least in part on receiving a request or a demand), among other examples.

In some aspects, the target cell information may indicate information associated with an activation request transmitted by the UE to the second network node. In some aspects, the activation request may be associated with a request or demand for activation of a set of resources or a configuration associated with the second network node. In some aspects, the information associated with the activation request may include information indicating a set of resources via which the activation request can be transmitted, a configuration or format of the activation request, whether the second network node is configured to transmit a response to the activation request, a set of resources via which a response to the activation request may be transmitted, a window (e.g., a time period or duration of time) during which the requested resources or configurations are to be activated, or an offset associated with the window (e.g., an amount of time between a transmission of the activation request and a start of the window or an amount of time between a reception of a response to the activation request and a start of the window), among other examples.

As shown by reference number 510, the first network node may transmit, and the UE may receive, request information associated with transmitting an activation request to the second network node. In some aspects, the UE may receive the request information via one or more of RRC signaling, one or more MAC CEs, or DCI, among other examples.

In some aspects, the activation request may be associated with obtaining, requesting, or activating resources, information, or configurations from the target cell. For example, the activation request may be associated with obtaining uplink timing information (e.g., a timing advance), communication of a CSI-RS, activation or allocation of IMRs, communication of an SRS, or a combination thereof.

In some aspects, the request information may include information associated with a transmission of the activation request. For example, the request information may indicate a set of resources for transmitting the activation request. In some aspects, the second network node may be configured to transmit a response to the activation request and the request information may indicate a set of resources for receiving the response from the second network node.

In some aspects, the request information may include information indicating the time period associated with communicating with the target cell. For example, the request information may indicate a time period during which the UE is to transmit a reference signal to or receive a reference signal from the second network node.

In some aspects, the information indicating the time period may indicate an offset value associated with the time period. In some aspects, the offset value may be relative to a time at which the activation request is transmitted or a time at which a response to the activation request is received. For example, the offset value may correspond to an amount of time between a time at which the activation request or the response to the activation request is received and a time corresponding to a start of the time period.

In some aspects, the request information may indicate what is to be requested by the UE from the second network node. For example, the request information may indicate that the UE is to transmit an activation request to request the activation of a set of resources (a set of IMRs) for transmitting (e.g., by the second network node or by the UE) a reference signal. As another example, the request information may indicate a type of the reference signal (e.g., a CSI-RS, an SRS, or an SSB, among other examples) for which activation is to be requested. As yet another example, the request information may indicate that the UE is to request activation of a configuration associated with the set of resources or the reference signal.

In some aspects, the list of resources or configurations included in the target cell information is known to the UE prior to the UE receiving the request information. For example, the list of resources or configurations may be pre-configured at the UE, specified by a wireless communication standard, or previously provided to the UE by the first network node or the second network node. In these aspects, the request information may include an index or other information that can be used to identify a particular resource or configuration from the list of resources or configurations.

In some aspects, the request information may indicate a type or a form of a signal via which the activation request is transmitted. In some aspects, the request information may indicate that the activation request is in the form of a PRACH. For example, the request information may indicate that the activation request is to be transmitted via a preamble or a payload of a message 1 of a 4-step RACH procedure or a message A of a 2-step RACH procedure.

In some aspects, the request information may indicate that the activation request is to be transmitted via a PUCCH communication. In some aspects, the request information may indicate a format of the PUCCH communication. For example, the request information may indicate that the format of the PUCCH communication may be a PUCCH format 0 or a PUCCH format 1.

In some aspects, the request information may indicate that the activation request corresponds to an SRS transmission, a PRACH transmission followed by an SRS transmission, or a PUCCH transmission followed by an SRS transmission.

In some aspects, the request information may include the target cell information. For example, the request information may include information indicating the one or more sets of resources associated with the second network node, the set of configurations associated with the second network node or the target cell, the information associated with the set of reference signals, and the information associated with the activation request.

In some aspects, the request information may include a portion of the target cell information. For example, the target cell information may include a list of resources. The first network node may select one or more of the listed resources and may include information identifying the selected resources in the request information. As another example, the target cell information may include a list of configurations associated with the listed resources. The first network node may identify a configuration from the list of configurations that is associated with the selected resources and may include information identifying the configuration in the request information.

In some aspects, the request information may include additional information. For example, the request information may include information associated with the serving cell, the target cell, the first network node, the second network node, or the activation request.

In some aspects, the request information may indicate a timing advance associated with the UE communicating with the second network node. In some aspects, the timing advance may be calculated or determined by the first network node based at least in part on information associated with the UE, the first network node, or the second network node. For example, the first network node may calculate the timing advance based at least in part on a difference in downlink reception timing of the target cell and the serving cell.

Additionally, or alternatively, the timing advance may be determined by the UE. For example, the UE may determine the timing advance based at least in part on a RACH procedure that was previously performed with the second network node or based on the difference in downlink reception timing of the target cell and the serving cell.

In some aspects, the request information may indicate an uplink grant. For example, the request information may indicate an uplink grant for the UE to transmit channel state feedback to the serving cell (or to the target cell via the serving cell). As another example, the request information may indicate an uplink grant for the UE to transmit the activation request (or a portion of the activation request, as described below) to the second network node via the first network node.

In some aspects, the request information may indicate a downlink grant. For example, the request information may indicate a downlink grant associated with the first network node forwarding a response to the activation or request, or uplink measurement data received from the second network node (e.g., via a backhaul link) to the UE.

As shown by reference number 515, the UE may transmit, and the second network node may receive, an activation request. In some aspects, the activation request may be transmitted based at least in part on receiving a communication from the first network node. For example, the activation request may be transmitted based at least in part on receiving the request information, an order (e.g., via a PDCCH), or a trigger signal, among other examples.

In some aspects, the communication may include information associated with the activation request. For example, the communication may include information indicating whether a CSI-RS, an IMR, or an SRS will be activated for the UE, a configuration associated with the CSI-RS, the IMR, or the SRS that is to be activated for the UE, a basis for transmitting the activation request, whether the UE is to request the activation of the CSI-RS, the IMR, or the SRS, a waveform associated with transmitting the activation request, a set of resources via which the activation request is to be transmitted, a timing advance associated with communicating with the target cell, a transmit power control associated with communicating with the target cell, an uplink grant for the UE to send acquired channel information associated with the target cell to the first network node, or other information associated with the CSI-RS, the IMR, or the SRS.

In some aspects, the activation request may be autonomously transmitted by the UE. In some aspects, the activation request may be transmitted based at least in part on a satisfaction of a condition. For example, the activation request may be transmitted based at least in part on a channel metric (e.g., an signal-to-noise ratio (SNR), an RSRP, a throughput, or a bandwidth, among other examples) associated with the target cell satisfying a threshold, or a channel metric associated with the serving cell failing to satisfy a threshold.

In some aspects, the activation request may be transmitted with a timing advance (e.g., indicated in the request information, indicated in the communication, or determined by the UE). For example, the activation request may be in the form of a PUCCH transmission or an SRS transmission, and the activation request may be transmitted with a timing advance based at least in part on the activation request being in the form of the PUCCH transmission of the SRS transmission.

In some aspects, the activation request may include information indicating a reason (or a portion of a reason) for the activation request. In some aspects, the reason for the activation request may correspond to a reference signal, a set of resources, or a configuration that the UE is requesting to be activated.

For example, the activation request (e.g., a payload of the activation request) may indicate a communication channel, a configuration, or a set of resources that the UE is requesting to be activated. As another example, the activation request may request a RACH resource, a transmission of an SSB by the second network node, a transmission of a positioning reference signal by the second network node, a transmission of a tracking reference signal by the second network node, a transmission of a CSI-RS by the second network node, a request for an IMR, or a transmission of an SRS by the UE.

In some aspects, the reason for the request may be indicated by one or more characteristics associated with a transmission of the request. For example, the resources or configuration requested to be activated may be indicated by the time or frequency resources via which the activation request is transmitted, a scrambling identifier associated with the activation request, a preamble identifier associated with the activation request, or an amount of cyclic shift associated with a transmission of the activation request.

In some aspects, the target cell information or the request information may indicate multiple resources (e.g., multiple CSI-RS resources, multiple IMRs, or multiple SRS resources, among other examples). In these aspects, the activation request may include information indicating one or more of the multiple resources.

In some aspects, the activation request may request a modification to a configuration or a set of resources. For example, the second network node may be configured to transmit an SSB at a first periodicity via a first set of resources. The activation request may request the second network node to transmit the SSB at a second periodicity or via additional resources to cause the SSB to be transmitted more frequently by the second network node.

In some aspects, one or more portions of the activation request may be transmitted to the second network node via the first network node. For example, a configured size of the activation request may prevent one or more portions of the information described above to be included in the activation request and the UE may transmit a second activation request to the first network node. The second activation request may include the one or more portions that were not included in the activation request transmitted directly to the second network node. The first network node may receive the second activation request and may forward the activation request (e.g., via a backhaul link) to the second network node.

In some aspects, the second network node may be configured to refrain from transmitting a response to the activation request. In these aspects, the UE may refrain from monitoring for a response to the activation request.

In some aspects, the second network node may be configured to transmit a response to the activation request. In these aspects, the UE may monitor for a response based at least in part on the second network node being configured to transmit a response to the activation request. As shown by reference number 520, the second network node may transmit, and the UE may receive, a response to the activation request.

In some aspects, the response may be received via a PDCCH. In some aspects, the response may be received via a PDSCH. In some aspects, the response may include feedback information. In some aspects, the feedback information (e.g., an ACK or a NACK) may indicate whether the activation request was successfully received by the second network node.

In some aspects, the feedback information may indicate that the activation request was not successfully received by the second network node and the UE may retransmit the request. In some aspects, the feedback information may indicate that the activation request was successfully received by the second network node and the UE or the second network node may transmit one or more reference signals, as described below with respect to reference number 525.

In some aspects, the feedback information may indicate whether the activation request is granted. For example, the activation request may request activation of a CSI-RS, an IMR, or an SRS and the feedback information may indicate whether the CSI-RS, the IMR, or the SRS is to be activated. As another example, the activation request may request activation of a configuration associated with a CSI-RS, an IMR, or an SRS, and the feedback information may indicate whether the configuration associated with the CSI-RS, the IMR, or the SRS is to be activated. As yet another example, the activation request may request activation of a set of resources associated with a CSI-RS, an IMR, or an SRS, and the feedback information may indicate whether the set of resources associated with the CSI-RS, the IMR, or the SRS is to be activated.

In some aspects, the response may indicate a modification to one or more portions of the activation request. For example, the activation request may indicate a particular resource and a particular configuration to be activated. The response may deny the request to activate the particular resource, the particular configuration, or both the particular resource and the particular configuration and may include information indicating another resource, another configuration, or both the other resource and the other configuration. The UE may determine that the other resource, the other configuration, or both the other resource and the other configuration are activated based at least in part on the response denying the request to activate the particular resource, the particular configuration, or both the particular resource and the particular configuration and including information indicating another resource, another configuration, or both the other resource and the other configuration.

In some aspects, the response may indicate a modification to a resource or a configuration. In some aspects, a set of configurations (e.g., a set of configurations associated with a CSI-RS, an IMR, or an SRS) may be (pre-)configured at the UE and the response may indicate a modification to one of the configured configurations.

In some aspects, the response may include additional information. For example, the response may include information indicating a timing advance, an uplink grant for providing channel state feedback to the second network node, or a downlink grant for the second network node to provide uplink measurement data to the UE.

As shown by reference number 525, the UE or the second network node may transmit one or more reference signals. In some aspects, the second network node may transmit one or more reference signals to the UE based at least in part on the activation request. For example, the second network node may transmit a CSI-RS, an SSB, a PTRS, or another type of reference signal to the UE via a set of activated resources and in accordance with an activated configuration.

In these aspects, the UE may perform one or more measurements based at least in part on the transmitted reference signals. For example, the second network node may perform one or more transmissions of a CSI-RS and the UE may perform one or more measurements to determine CSI associated with a beam or communication channel via which the CSI-RS was transmitted.

In some aspects, the UE may transmit one or more reference signals to the second network node. For example, the UE may transmit one or more SRSs to the second network node via a set of activated resources and in accordance with an activated configuration. The second network node may perform one or more measurements based at least in part on the transmitted SRS(s) to determine uplink measurement data associated with the UE.

In some aspects, a set of beams associated with the transmission of the one or more reference signals are preconfigured. In some aspects, the set of beams are indicated in the request information. In some aspects, the set of beams are indicated in the response to the activation request.

In some aspects, a beam via which the one or more reference signals are transmitted may be QCL’ed with a beam via which the activation request is transmitted. In some aspects, the beam via which the one or more reference signals are transmitted may be QCL’ed with a beam indicated in the response to the activation request. In some aspects, the beam via which the one or more reference signals are transmitted may be QCL’d with a beam via which the response to the activation request is received.

As shown by reference number 530, the UE or the second network node may transmit a measurement result. In some aspects, the UE may perform the one or more measurements. In these aspects, the UE may transmit a measurement result indicating a result of performing the one or more measurements to the second network node.

In some aspects, the UE may transmit the measurement result directly to the second network node. In some aspects, the UE may transmit the measurement result to the first network node. For example, the UE may transmit the measurement result to the first network node to enable the first network node to determine whether a handover procedure is to be performed. As another example, the UE may transmit the measurement result to the first network node to cause the first network node to transmit the measurement result to the second network node (e.g., via a backhaul link).

In some aspects, the UE may transmit the measurement result to the second network node after performing a handover procedure. In these aspects, the UE may perform multiple measurements based at least in part on multiple reference signals transmitted by the second network node. In some aspects, the UE may filter the measurement results before reporting the measurement results to the second network node.

In some aspects, the second network node may perform the one or more measurements. In these aspects, the second network node may transmit a measurement result indicating a result of performing the one or more measurements to the UE. In some aspects, the second network node may transmit the measurement result directly to the UE or indirectly via the first network node.

In some aspects, a handover decision (e.g., a decision as to whether to perform a handover procedure) may be made based at least in part on the measurement result. In some aspects, the handover decision may be made by the UE. For example, the UE may determine whether a difference between a channel metric associated with the first network node and a channel metric associated with the second network node satisfies a threshold, based at least in part on the measurement result.

In some aspects, the UE may determine whether to perform a handover procedure with the second network node based at least in part on whether the difference between the channel metrics satisfies the threshold. In some aspects, the UE may transmit information indicating the handover decision or information indicating whether the difference between the channel metrics satisfies the threshold to the first network node.

In some aspects, the handover decision may be made by the first network node. For example, the first network node may receive the measurement result from the UE or the second network node. The first network node may determine whether a difference between a channel metric associated with the first network node and a channel metric associated with the second network node satisfies a threshold based at least in part on the measurement result. The first network node may determine whether a handover procedure is to be performed based at least in part on whether the difference between the channel metrics satisfies the threshold.

As another example, the first network node may receive (e.g., from the UE) information indicating the handover decision made by the UE or the information indicating whether the difference between the channel metrics satisfies the threshold. The first network node may determine whether a handover procedure is to be performed based at least in part on the handover decision made by the UE or based at least in part on whether the difference between the channel metrics satisfies the threshold.

In some aspects, the first network node may determine that the handover procedure is to be performed between the UE and the second network node. In some aspects, the first network node may transmit, to the UE, information indicating that the UE is to perform the handover procedure with the second network node. As shown by reference number 535, the UE and the second network node may perform the handover procedure.

As indicated above, FIG. 5 is provided as an example. Other examples may differ from what is described with respect to FIG. 5.

FIG. 6 is a diagram illustrating an example process 600 performed, for example, at a UE or an apparatus of a UE. Example process 600 is an example where the apparatus or the UE (e.g., UE 120) performs operations associated with acquisition of target cell CSI.

As shown in FIG. 6, in some aspects, process 600 may include receiving information associated with transmitting a request, wherein the request is configured to trigger, on a target cell, activation of a CSI-RS, an IMR, an SRS, or a combination thereof (block 610). For example, the UE (e.g., using reception component 802 or communication manager 806, depicted in FIG. 8) may receive information associated with transmitting a request, wherein the request is configured to trigger, on a target cell, activation of a CSI-RS, an IMR, an SRS, or a combination thereof, as described above.

As further shown in FIG. 6, in some aspects, process 600 may include transmitting the request to a network node associated with the target cell, wherein the request is generated based at least in part on the information associated with transmitting the request (block 620). For example, the UE (e.g., using transmission component 804 or communication manager 806, depicted in FIG. 8) may transmit the request to a network node associated with the target cell, wherein the request is generated based at least in part on the information associated with transmitting the request, as described above.

Process 600 may include additional aspects, such as any single aspect or any combination of aspects described below or in connection with one or more other processes described elsewhere herein.

In a first aspect, process 600 includes communicating with the network node based at least in part on the request.

In a second aspect, alone or in combination with the first aspect, the target cell comprises a lower layer triggered mobility candidate cell.

In a third aspect, alone or in combination with one or more of the first and second aspects, the information associated with transmitting the request is received via a serving cell associated with the UE.

In a fourth aspect, alone or in combination with one or more of the first through third aspects, the information associated with transmitting the request includes information indicating a set of CSI-RS resources associated with the target cell, a set of CSI-RS configurations associated with the target cell, a set of IMRs associated with the target cell, a set of IMR configurations associated with the target cell, a set of SRS resources associated with the target cell, a set of SRS configurations associated with the target cell, or a combination thereof.

In a fifth aspect, alone or in combination with one or more of the first through fourth aspects, the information associated with transmitting the request includes information indicating a quantity of ports associated with the network node, a bandwidth associated with the network node, a density in a time and frequency domain, a quasi co-location relationship, a scrambling identifier associated with the network node, or a combination thereof.

In a sixth aspect, alone or in combination with one or more of the first through fifth aspects, the information associated with transmitting the request includes information indicating a set of resources for transmitting the request, a set of resources for receiving, from the network node, a response to the request, a time period associated with communicating with the target cell based at least in part on the request, or a combination thereof.

In a seventh aspect, alone or in combination with one or more of the first through sixth aspects, the information associated with transmitting the request includes the information indicating the time period, and the information indicating the time period includes information indicating an offset value associated with a start of the time period.

In an eighth aspect, alone or in combination with one or more of the first through seventh aspects, the offset value indicates a time offset relative to a transmission of a physical random access channel or a reception of a response to the request.

In a ninth aspect, alone or in combination with one or more of the first through eighth aspects, the request includes a request for information indicating a timing advance associated with communicating with the network node.

In a tenth aspect, alone or in combination with one or more of the first through ninth aspects, multiple resources are configured for the CSI-RS, the IMR, the SRS, or a combination thereof, and the request includes information indicating one of the multiple resources.

In an eleventh aspect, alone or in combination with one or more of the first through tenth aspects, the request includes a request for a random access channel resource, a transmission of a synchronization signal block, a transmission of a positioning reference signal, or a transmission of a tracking reference signal.

In a twelfth aspect, alone or in combination with one or more of the first through eleventh aspects, a type of signal via which the request is transmitted has a form of a physical random access channel (PRACH), a PUCCH, the SRS, the PRACH followed by the SRS, or the PUCCH followed by the SRS.

In a thirteenth aspect, alone or in combination with one or more of the first through twelfth aspects, the form of the PRACH comprises a preamble or a payload of a RACH message 1 or a RACH message A, and the form of the PUCCH comprises a PUCCH format 0 or a PUCCH format 1.

In a fourteenth aspect, alone or in combination with one or more of the first through thirteenth aspects, the type of the signal has the form of the PUCCH or the SRS, and the request includes information indicating a timing advance.

In a fifteenth aspect, alone or in combination with one or more of the first through fourteenth aspects, the UE determines the timing advance based at least in part on a previously performed RACH procedure or based at least in part on a difference in downlink reception timing between a source cell and the target cell.

In a sixteenth aspect, alone or in combination with one or more of the first through fifteenth aspects, the information associated with transmitting the request indicates the timing advance.

In a seventeenth aspect, alone or in combination with one or more of the first through sixteenth aspects, the request indicates a channel or configuration associated with the activation of the CSI-RS, the IMR, the SRS, or the combination thereof.

In an eighteenth aspect, alone or in combination with one or more of the first through seventeenth aspects, the channel or configuration is indicated based at least in part on a time resource via which the request is transmitted, a frequency resource via which the request is transmitted, a scrambling identifier, a preamble identifier, a cyclic shift, or information included in a payload of an uplink channel.

In a nineteenth aspect, alone or in combination with one or more of the first through eighteenth aspects, process 600 includes receiving a communication from a serving cell, wherein the request is transmitted based at least in part on the communication.

In a twentieth aspect, alone or in combination with one or more of the first through nineteenth aspects, the communication is received via a physical downlink control channel.

In a twenty-first aspect, alone or in combination with one or more of the first through twentieth aspects, the communication indicates whether the CSI-RS, the IMR, or the SRS will be activated for the UE, a configuration associated with the CSI-RS, the IMR, or the SRS, a basis for transmitting the request, whether the UE is to request the activation of the CSI-RS, the IMR, or the SRS, a waveform associated with transmitting the request, resources via which the request is to be transmitted, a timing advance associated with communicating with the target cell, a transmit power control associated with communicating with the target cell, an uplink grant for the UE to send acquired channel information associated with the target cell to a serving cell, or other information associated with the CSI-RS, the IMR, or the SRS.

In a twenty-second aspect, alone or in combination with one or more of the first through twenty-first aspects, the request is transmitted based at least in part on a satisfaction of a condition.

In a twenty-third aspect, alone or in combination with one or more of the first through twenty-second aspects, the condition is associated with a channel strength associated with the target cell, a channel strength associated with a serving cell, a channel quality associated with the target cell, or a channel quality associated with the serving cell.

In a twenty-fourth aspect, alone or in combination with one or more of the first through twenty-third aspects, the UE refrains from monitoring for a response to the request from the target cell.

In a twenty-fifth aspect, alone or in combination with one or more of the first through twenty-fourth aspects, process 600 includes receiving, from the target cell, a response to the request via a physical downlink control channel or a physical downlink shared channel, wherein the response includes information indicating whether the CSI-RS, the IMR, or the SRS is to be activated, a configuration associated with the CSI-RS, the IMR, or the SRS, resources associated with the CSI-RS, the IMR, or the SRS, a modification to a configured configuration associated with the CSI-RS, the IMR, or the SRS, a timing advance, an uplink grant for providing channel state feedback to the target cell, or a downlink grant for providing uplink measurement data to the UE.

In a twenty-sixth aspect, alone or in combination with one or more of the first through twenty-fifth aspects, a beam via which the CSI-RS, the IMR, or the SRS is transmitted is quasi co-located with a beam via which the request is transmitted or a beam indicated in a response to the request.

In a twenty-seventh aspect, alone or in combination with one or more of the first through twenty-sixth aspects, a set of beams associated with a transmission of the CSI-RS, the IMR, or the SRS are preconfigured, indicated in the information associated with transmitting the request, or indicated in a response to the request.

In a twenty-eighth aspect, alone or in combination with one or more of the first through twenty-seventh aspects, the request is configured to trigger, on the target cell, activation of the CSI-RS or the IMR, and process 600 includes performing one or more measurements based at least in part on activated CSI-RS resources or activated IMR resources.

In a twenty-ninth aspect, alone or in combination with one or more of the first through twenty-eighth aspects, process 600 includes transmitting a result of performing the one or more measurements to the target cell or a serving cell.

In a thirtieth aspect, alone or in combination with one or more of the first through twenty-ninth aspects, process 600 includes transmitting a result of performing the one or more measurements to the serving cell to cause the serving cell to transmit the result to the target cell.

In a thirty-first aspect, alone or in combination with one or more of the first through thirtieth aspects, an event associated with reporting or executing a handover with the target cell is triggered based at least in part on a result of performing the one or more measurements.

In a thirty-second aspect, alone or in combination with one or more of the first through thirty-first aspects, the request is configured to trigger, on the target cell, activation of the SRS, and process 600 includes transmitting the SRS, and receiving a result of one or more measurements associated with the transmitted SRS.

In a thirty-third aspect, alone or in combination with one or more of the first through thirty-second aspects, the result of the one or more measurements is received from the target cell, and process 600 includes transmitting the result of the one or more measurements to a serving cell.

In a thirty-fourth aspect, alone or in combination with one or more of the first through thirty-third aspects, an event for reporting or executing a handover is triggered based at least in part on the result of the one or more measurements.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with acquisition of target cell CSI.

As shown in FIG. 7, in some aspects, process 700 may include transmitting, to a UE, information associated with transmitting a request, wherein the request is configured to trigger, on a target cell, activation of a CSI-RS, an IMR, an SRS, or a combination thereof (block 710). For example, the network node (e.g., using transmission component 904 or communication manager 906, depicted in FIG. 9) may transmit, to a UE, information associated with transmitting a request, wherein the request is configured to trigger, on a target cell, activation of a CSI-RS, an IMR, an SRS, or a combination thereof, as described above.

As further shown in FIG. 7, in some aspects, process 700 may include receiving information associated with the activation of the CSI-RS, the IMR, or the SRS (block 720). For example, the network node (e.g., using reception component 902 or communication manager 906, depicted in FIG. 9) may receive information associated with the activation of the CSI-RS, the IMR, or the SRS, as described above.

Process 700 may include additional aspects, such as any single aspect or any combination of aspects described below or in connection with one or more other processes described elsewhere herein.

In a first aspect, the information associated with the activation of the CSI-RS, the IMR, or the SRS is received from the UE or the target cell.

In a second aspect, alone or in combination with the first aspect, the target cell comprises a lower layer triggered mobility candidate cell.

In a third aspect, alone or in combination with one or more of the first and second aspects, the network node is associated with a serving cell associated with the UE.

In a fourth aspect, alone or in combination with one or more of the first through third aspects, the information associated with transmitting the request includes information indicating a set of CSI-RS resources associated with the target cell, a set of CSI-RS configurations associated with the target cell, a set of IMRs associated with the target cell, a set of IMR configurations associated with the target cell, a set of SRS resources associated with the target cell, a set of SRS configurations associated with the target cell, or a combination thereof.

In a fifth aspect, alone or in combination with one or more of the first through fourth aspects, the information associated with transmitting the request includes information indicating a quantity of ports associated with a network node, a bandwidth associated with the network node, a density in a time and frequency domain, a quasi co-location relationship, a scrambling identifier associated with the network node, or a combination thereof.

In a sixth aspect, alone or in combination with one or more of the first through fifth aspects, the information associated with transmitting the request includes information indicating a set of resources for transmitting the request, a set of resources for receiving, from the target cell, a response to the request, a time period associated with communicating with the target cell based at least in part on the request, or a combination thereof.

In a seventh aspect, alone or in combination with one or more of the first through sixth aspects, the information associated with transmitting the request includes the information indicating the time period, and the information indicating the time period includes information indicating an offset value associated with a start of the time period.

In an eighth aspect, alone or in combination with one or more of the first through seventh aspects, the offset value indicates a time offset relative to a transmission of a physical random access channel or a reception of a response to the request.

In a ninth aspect, alone or in combination with one or more of the first through eighth aspects, the information associated with transmitting the request indicates a timing advance.

In a tenth aspect, alone or in combination with one or more of the first through ninth aspects, process 700 includes transmitting a communication from the target cell to the UE, wherein the request is transmitted based at least in part on the communication.

In an eleventh aspect, alone or in combination with one or more of the first through tenth aspects, the communication indicates whether the CSI-RS, the IMR, or the SRS will be activated for the UE, a configuration associated with the CSI-RS, the IMR, or the SRS, a basis for transmitting the request, whether the UE is to request the activation of the CSI-RS, the IMR, or the SRS, a waveform associated with transmitting the request, resources via which the request is to be transmitted, a timing advance associated with communicating with the target cell, a transmit power control (TPC) associated with communicating with the target cell, an uplink grant for the UE to send acquired channel information associated with the target cell to a serving cell, or other information associated with the CSI-RS, the IMR, or the SRS.

In a twelfth aspect, alone or in combination with one or more of the first through eleventh aspects, the request is transmitted based at least in part on a satisfaction of a condition.

In a thirteenth aspect, alone or in combination with one or more of the first through twelfth aspects, the condition is associated with a channel strength associated with the target cell, a channel strength associated with a serving cell, a channel quality associated with the target cell, or a channel quality associated with the serving cell.

In a fourteenth aspect, alone or in combination with one or more of the first through thirteenth aspects, process 700 includes transmitting, to the UE, a response to the request via a physical downlink control channel or a physical downlink shared channel, wherein the response includes information indicating whether the CSI-RS, the IMR, or the SRS is to be activated, a configuration associated with the CSI-RS, the IMR, or the SRS, resources associated with the CSI-RS, the IMR, or the SRS, a modification to a configured configuration associated with the CSI-RS, the IMR, or the SRS, a timing advance, an uplink grant for providing channel state feedback to the target cell, or a downlink grant for providing uplink measurement data to the UE.

In a fifteenth aspect, alone or in combination with one or more of the first through fourteenth aspects, a beam via which the CSI-RS, the IMR, or the SRS is transmitted is quasi co-located with a beam via which the request is transmitted or a beam indicated in a response to the request.

In a sixteenth aspect, alone or in combination with one or more of the first through fifteenth aspects, a set of beams associated with a transmission of the CSI-RS, the IMR, or the SRS are preconfigured, indicated in the information associated with transmitting the request, or indicated in a response to the request.

In a seventeenth aspect, alone or in combination with one or more of the first through sixteenth aspects, the request is configured to trigger, on the target cell, activation of the CSI-RS or the IMR.

In an eighteenth aspect, alone or in combination with one or more of the first through seventeenth aspects, process 700 includes receiving a result of performing one or more measurements performed based at least in part on the activation of the CSI-RS or the IMR, and transmitting the result to the UE.

In a nineteenth aspect, alone or in combination with one or more of the first through eighteenth aspects, process 700 includes receiving a result of performing one or more measurements performed based at least in part on the activation of the CSI-RS or the IMR, and transmitting the result to the target cell.

In a twentieth aspect, alone or in combination with one or more of the first through nineteenth aspects, an event associated with reporting or executing a handover with the target cell is triggered based at least in part on a result of performing the one or more measurements.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 2-5. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive information associated with transmitting a request, wherein the request is configured to trigger, on a target cell, activation of a CSI-RS, an IMR, an SRS, or a combination thereof. The transmission component 804 may transmit the request to a network node associated with the target cell, wherein the request is generated based at least in part on the information associated with transmitting the request.

The communication manager 806 may communicate with the network node based at least in part on the request.

The reception component 802 may receive a communication from a serving cell, wherein the request is transmitted based at least in part on the communication.

The reception component 802 may receive, from the target cell, a response to the request via a physical downlink control channel or a physical downlink shared channel, wherein the response includes information indicating whether the CSI-RS, the IMR, or the SRS is to be activated, a configuration associated with the CSI-RS, the IMR, or the SRS, resources associated with the CSI-RS, the IMR, or the SRS, a modification to a configured configuration associated with the CSI-RS, the IMR, or the SRS, a timing advance, an uplink grant for providing channel state feedback to the target cell, or a downlink grant for providing uplink measurement data to the UE.

The transmission component 804 may transmit a result of performing the one or more measurements to the target cell or a serving cell.

The transmission component 804 may transmit a result of performing the one or more measurements to the serving cell to cause the serving cell to transmit the result to the target cell.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 2-5. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a UE, information associated with transmitting a request, wherein the request is configured to trigger, on a target cell, activation of a CSI-RS, an IMR, an SRS, or a combination thereof. The reception component 902 may receive information associated with the activation of the CSI-RS, the IMR, or the SRS.

The transmission component 904 may transmit a communication from the target cell to the UE, wherein the request is transmitted based at least in part on the communication.

The transmission component 904 may transmit, to the UE, a response to the request via a physical downlink control channel or a physical downlink shared channel, wherein the response includes information indicating whether the CSI-RS, the IMR, or the SRS is to be activated, a configuration associated with the CSI-RS, the IMR, or the SRS, resources associated with the CSI-RS, the IMR, or the SRS, a modification to a configured configuration associated with the CSI-RS, the IMR, or the SRS, a timing advance, an uplink grant for providing channel state feedback to the target cell, or a downlink grant for providing uplink measurement data to the UE.

The reception component 902 may receive a result of performing one or more measurements performed based at least in part on the activation of the CSI-RS or the IMR.

The transmission component 904 may transmit the result to the UE.

The reception component 902 may receive a result of performing one or more measurements performed based at least in part on the activation of the CSI-RS or the IMR.

The transmission component 904 may transmit the result to the target cell.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving information associated with transmitting a request, wherein the request is configured to trigger, on a target cell, activation of a CSI-RS, an IMR, an SRS, or a combination thereof; and transmitting the request to a network node associated with the target cell, wherein the request is generated based at least in part on the information associated with transmitting the request.

Aspect 2: The method of Aspect 1, further comprising: communicating with the network node based at least in part on the request.

Aspect 3: The method of any of Aspects 1-2, wherein the target cell comprises a lower layer triggered mobility candidate cell.

Aspect 4: The method of any of Aspects 1-3, wherein the information associated with transmitting the request is received via a serving cell associated with the UE.

Aspect 5: The method of any of Aspects 1-4, wherein the information associated with transmitting the request includes information indicating: a set of CSI-RS resources associated with the target cell, a set of CSI-RS configurations associated with the target cell, a set of IMRs associated with the target cell, a set of IMR configurations associated with the target cell, a set of SRS resources associated with the target cell, a set of SRS configurations associated with the target cell, or a combination thereof.

Aspect 6: The method of any of Aspects 1-5, wherein the information associated with transmitting the request includes information indicating: a quantity of ports associated with the network node, a bandwidth associated with the network node, a density in a time and frequency domain, a quasi co-location relationship, a scrambling identifier associated with the network node, or a combination thereof.

Aspect 7: The method of any of Aspects 1-6, wherein the information associated with transmitting the request includes information indicating: a set of resources for transmitting the request, a set of resources for receiving, from the network node, a response to the request, a time period associated with communicating with the target cell based at least in part on the request, or a combination thereof.

Aspect 8: The method of Aspect 7, wherein the information associated with transmitting the request includes the information indicating the time period, and wherein the information indicating the time period includes information indicating an offset value associated with a start of the time period.

Aspect 9: The method of Aspect 8, wherein the offset value indicates a time offset relative to a transmission of a physical random access channel or a reception of a response to the request.

Aspect 10: The method of any of Aspects 1-9, wherein the request includes a request for information indicating a timing advance associated with communicating with the network node.

Aspect 11: The method of any of Aspects 1-10, wherein multiple resources are configured for the CSI-RS, the IMR, the SRS, or a combination thereof, and wherein the request includes information indicating one of the multiple resources.

Aspect 12: The method of any of Aspects 1-11, wherein the request includes a request for a random access channel resource, a transmission of a synchronization signal block, a transmission of a positioning reference signal, or a transmission of a tracking reference signal.

Aspect 13: The method of any of Aspects 1-12, wherein a type of signal via which the request is transmitted has a form of a PRACH, a PUCCH, the SRS, the PRACH followed by the SRS, or the PUCCH followed by the SRS.

Aspect 14: The method of Aspect 13, wherein the form of the PRACH comprises a preamble or a payload of a random access channel (RACH) message 1 or a RACH message A, and wherein the form of the PUCCH comprises a PUCCH format 0 or a PUCCH format 1.

Aspect 15: The method of Aspect 13, wherein the type of the signal has the form of the PUCCH or the SRS, and wherein the request includes information indicating a timing advance.

Aspect 16: The method of Aspect 15, wherein the UE determines the timing advance based at least in part on a previously performed RACH procedure or based at least in part on a difference in downlink reception timing between a source cell and the target cell.

Aspect 17: The method of Aspect 15, wherein the information associated with transmitting the request indicates the timing advance.

Aspect 18: The method of any of Aspects 1-17, wherein the request indicates a channel or configuration associated with the activation of the CSI-RS, the IMR, the SRS, or the combination thereof.

Aspect 19: The method of Aspect 18, wherein the channel or configuration is indicated based at least in part on a time resource via which the request is transmitted, a frequency resource via which the request is transmitted, a scrambling identifier, a preamble identifier, a cyclic shift, or information included in a payload of an uplink channel.

Aspect 20: The method of any of Aspects 1-19, further comprising: receiving a communication from a serving cell, wherein the request is transmitted based at least in part on the communication.

Aspect 21: The method of Aspect 20, wherein the communication is received via a physical downlink control channel.

Aspect 22: The method of Aspect 20, wherein the communication indicates: whether the CSI-RS, the IMR, or the SRS will be activated for the UE, a configuration associated with the CSI-RS, the IMR, or the SRS, a basis for transmitting the request, whether the UE is to request the activation of the CSI-RS, the IMR, or the SRS, a waveform associated with transmitting the request, resources via which the request is to be transmitted, a timing advance associated with communicating with the target cell, a transmit power control associated with communicating with the target cell, an uplink grant for the UE to send acquired channel information associated with the target cell to a serving cell, or other information associated with the CSI-RS, the IMR, or the SRS.

Aspect 23: The method of any of Aspects 1-22, wherein the request is transmitted based at least in part on a satisfaction of a condition.

Aspect 24: The method of Aspect 23, wherein the condition is associated with a channel strength associated with the target cell, a channel strength associated with a serving cell, a channel quality associated with the target cell, or a channel quality associated with the serving cell.

Aspect 25: The method of any of Aspects 1-24, wherein the UE refrains from monitoring for a response to the request from the target cell.

Aspect 26: The method of any of Aspects 1-25, further comprising: receiving, from the target cell, a response to the request via a physical downlink control channel or a physical downlink shared channel, wherein the response includes: information indicating whether the CSI-RS, the IMR, or the SRS is to be activated, a configuration associated with the CSI-RS, the IMR, or the SRS, resources associated with the CSI-RS, the IMR, or the SRS, a modification to a configured configuration associated with the CSI-RS, the IMR, or the SRS, a timing advance, an uplink grant for providing channel state feedback to the target cell, or a downlink grant for providing uplink measurement data to the UE.

Aspect 27: The method of any of Aspects 1-26, wherein a beam via which the CSI-RS, the IMR, or the SRS is transmitted is quasi co-located with a beam via which the request is transmitted or a beam indicated in a response to the request.

Aspect 28: The method of any of Aspects 1-27, wherein a set of beams associated with a transmission of the CSI-RS, the IMR, or the SRS are preconfigured, indicated in the information associated with transmitting the request, or indicated in a response to the request.

Aspect 29: The method of any of Aspects 1-28, wherein the request is configured to trigger, on the target cell, activation of the CSI-RS or the IMR, the method further comprising: performing one or more measurements based at least in part on activated CSI-RS resources or activated IMR resources.

Aspect 30: The method of Aspect 29, further comprising: transmitting a result of performing the one or more measurements to the target cell or a serving cell.

Aspect 31: The method of Aspect 29, further comprising: transmitting a result of performing the one or more measurements to the serving cell to cause the serving cell to transmit the result to the target cell.

Aspect 32: The method of Aspect 29, wherein an event associated with reporting or executing a handover with the target cell is triggered based at least in part on a result of performing the one or more measurements.

Aspect 33: The method of any of Aspects 1-32, wherein the request is configured to trigger, on the target cell, activation of the SRS, the method further comprising: transmitting the SRS; and receiving a result of one or more measurements associated with the transmitted SRS.

Aspect 34: The method of Aspect 33, wherein the result of the one or more measurements is received from the target cell, the method further comprising: transmitting the result of the one or more measurements to a serving cell.

Aspect 35: The method of Aspect 33, wherein an event for reporting or executing a handover is triggered based at least in part on the result of the one or more measurements.

Aspect 36: A method of wireless communication performed by a network node, comprising: transmitting, to a UE, information associated with transmitting a request, wherein the request is configured to trigger, on a target cell, activation of a CSI-RS, an IMR, an SRS, or a combination thereof; and receiving information associated with the activation of the CSI-RS, the IMR, or the SRS.

Aspect 37: The method of Aspect 36, wherein the information associated with the activation of the CSI-RS, the IMR, or the SRS is received from the UE or the target cell.

Aspect 38: The method of any of Aspects 36-37, wherein the target cell comprises a lower layer triggered mobility candidate cell.

Aspect 39: The method of any of Aspects 36-38, wherein the network node is associated with a serving cell associated with the UE.

Aspect 40: The method of any of Aspects 36-39, wherein the information associated with transmitting the request includes information indicating: a set of CSI-RS resources associated with the target cell, a set of CSI-RS configurations associated with the target cell, a set of IMRs associated with the target cell, a set of IMR configurations associated with the target cell, a set of SRS resources associated with the target cell, a set of SRS configurations associated with the target cell, or a combination thereof.

Aspect 41: The method of any of Aspects 36-40, wherein the information associated with transmitting the request includes information indicating: a quantity of ports associated with a network node, a bandwidth associated with the network node, a density in a time and frequency domain, a quasi co-location relationship, a scrambling identifier associated with the network node, or a combination thereof.

Aspect 42: The method of any of Aspects 36-41, wherein the information associated with transmitting the request includes information indicating a set of resources for transmitting the request, a set of resources for receiving, from the target cell, a response to the request, a time period associated with communicating with the target cell based at least in part on the request, or a combination thereof.

Aspect 43: The method of Aspect 42, wherein the information associated with transmitting the request includes the information indicating the time period, and wherein the information indicating the time period includes information indicating an offset value associated with a start of the time period.

Aspect 44: The method of Aspect 43, wherein the offset value indicates a time offset relative to a transmission of a physical random access channel or a reception of a response to the request.

Aspect 45: The method of any of Aspects 36-44, wherein the information associated with transmitting the request indicates a timing advance.

Aspect 46: The method of any of Aspects 36-45, further comprising: transmitting a communication from the target cell to the UE, wherein the request is transmitted based at least in part on the communication.

Aspect 47: The method of Aspect 46, wherein the communication indicates whether the CSI-RS, the IMR, or the SRS will be activated for the UE, a configuration associated with the CSI-RS, the IMR, or the SRS, a basis for transmitting the request, whether the UE is to request the activation of the CSI-RS, the IMR, or the SRS, a waveform associated with transmitting the request, resources via which the request is to be transmitted, a timing advance associated with communicating with the target cell, a transmit power control associated with communicating with the target cell, an uplink grant for the UE to send acquired channel information associated with the target cell to a serving cell, or other information associated with the CSI-RS, the IMR, or the SRS.

Aspect 48: The method of any of Aspects 36-47, wherein the request is transmitted based at least in part on a satisfaction of a condition.

Aspect 49: The method of Aspect 48, wherein the condition is associated with a channel strength associated with the target cell, a channel strength associated with a serving cell, a channel quality associated with the target cell, or a channel quality associated with the serving cell.

Aspect 50: The method of any of Aspects 36-49, further comprising: transmitting, to the UE, a response to the request via a physical downlink control channel or a physical downlink shared channel, wherein the response includes information indicating whether the CSI-RS, the IMR, or the SRS is to be activated, a configuration associated with the CSI-RS, the IMR, or the SRS, resources associated with the CSI-RS, the IMR, or the SRS, a modification to a configured configuration associated with the CSI-RS, the IMR, or the SRS, a timing advance, an uplink grant for providing channel state feedback to the target cell, or a downlink grant for providing uplink measurement data to the UE.

Aspect 51: The method of any of Aspects 36-50, wherein a beam via which the CSI-RS, the IMR, or the SRS is transmitted is quasi co-located with a beam via which the request is transmitted or a beam indicated in a response to the request.

Aspect 52: The method of any of Aspects 36-51, wherein a set of beams associated with a transmission of the CSI-RS, the IMR, or the SRS are preconfigured, indicated in the information associated with transmitting the request, or indicated in a response to the request.

Aspect 53: The method of any of Aspects 36-52, wherein the request is configured to trigger, on the target cell, activation of the CSI-RS or the IMR.

Aspect 54: The method of Aspect 53, further comprising: receiving a result of performing one or more measurements performed based at least in part on the activation of the CSI-RS or the IMR; and transmitting the result to the UE.

Aspect 55: The method of Aspect 53, further comprising: receiving a result of performing one or more measurements performed based at least in part on the activation of the CSI-RS or the IMR; and transmitting the result to the target cell.

Aspect 56: The method of Aspect 53, wherein an event associated with reporting or executing a handover with the target cell is triggered based at least in part on a result of performing the one or more measurements.

Aspect 57: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-56.

Aspect 58: An apparatus for wireless communication at a device, the apparatus comprising one or more memories and one or more processors coupled to the one or more memories, the one or more processors configured to cause the device to perform the method of one or more of Aspects 1-56.

Aspect 59: An apparatus for wireless communication, the apparatus comprising at least one means for performing the method of one or more of Aspects 1-56.

Aspect 60: A non-transitory computer-readable medium storing code for wireless communication, the code comprising instructions executable by one or more processors to perform the method of one or more of Aspects 1-56.

Aspect 61: A non-transitory computer-readable medium storing a set of instructions for wireless communication, the set of instructions comprising one or more instructions that, when executed by one or more processors of a device, cause the device to perform the method of one or more of Aspects 1-56.

Aspect 62: A device for wireless communication, the device comprising a processing system that includes one or more processors and one or more memories coupled with the one or more processors, the processing system configured to cause the device to perform the method of one or more of Aspects 1-56.

Aspect 63: An apparatus for wireless communication at a device, the apparatus comprising one or more memories and one or more processors coupled to the one or more memories, the one or more processors individually or collectively configured to cause the device to perform the method of one or more of Aspects 1-56.

Aspect 64: A device comprising a processing system that includes one or more processors and one or more code-storing memories coupled with the one or more processors, the processing system configured to cause the device to perform the method of one or more of Aspects 1-56.

Aspect 65: A device comprising a processing system that includes processor circuitry and code-storing memory circuitry, the processing system configured to cause the device to perform the method of one or more of Aspects 1-56.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive information associated with transmitting a request, wherein the request is configured to trigger, on a target cell, activation of a channel state information reference signal (CSI-RS), an interference measurement resource (IMR), a sounding reference signal (SRS), or a combination thereof; and
transmit the request to a network node associated with the target cell, wherein the request is generated based at least in part on the information associated with transmitting the request.

2. The UE of claim 1, wherein the processing system is configured to cause the UE to:
communicate with the network node based at least in part on the request.

3. The UE of claim 1, wherein the target cell comprises a lower layer triggered mobility candidate cell.

4. The UE of claim 1, wherein the information associated with transmitting the request is received via a serving cell associated with the UE.

5. The UE of claim 1, wherein the information associated with transmitting the request includes information indicating:
a set of CSI-RS resources associated with the target cell,
a set of CSI-RS configurations associated with the target cell,
a set of IMRs associated with the target cell,
a set of IMR configurations associated with the target cell,
a set of SRS resources associated with the target cell,
a set of SRS configurations associated with the target cell, or
a combination thereof.

6. The UE of claim 1, wherein the information associated with transmitting the request includes information indicating:
a quantity of ports associated with the network node,
a bandwidth associated with the network node,
a density in a time and frequency domain,
a quasi co-location relationship,
a scrambling identifier associated with the network node, or
a combination thereof.

7. The UE of claim 1, wherein the information associated with transmitting the request includes information indicating:
a set of resources for transmitting the request,
a set of resources for receiving, from the network node, a response to the request,
a time period associated with communicating with the target cell based at least in part on the request,
or a combination thereof.

8. The UE of claim 7, wherein the information associated with transmitting the request includes the information indicating the time period, and wherein the information indicating the time period includes information indicating an offset value associated with a start of the time period.

9. The UE of claim 8, wherein the offset value indicates a time offset relative to a transmission of a physical random access channel or a reception of a response to the request.

10. The UE of claim 1, wherein the request includes a request for information indicating a timing advance associated with communicating with the network node.

11. The UE of claim 1, wherein multiple resources are configured for the CSI-RS, the IMR, the SRS, or a combination thereof, and wherein the request includes information indicating one of the multiple resources.

12. The UE of claim 1, wherein the request includes a request for a random access channel resource, a transmission of a synchronization signal block, a transmission of a positioning reference signal, or a transmission of a tracking reference signal.

13. The UE of claim 1, wherein a type of signal via which the request is transmitted has a form of a physical random access channel (PRACH), a physical uplink control channel (PUCCH), the SRS, the PRACH followed by the SRS, or the PUCCH followed by the SRS.

14. The UE of claim 13, wherein the form of the PRACH comprises a preamble or a payload of a random access channel (RACH) message 1 or a RACH message A, and wherein the form of the PUCCH comprises a PUCCH format 0 or a PUCCH format 1.

15. The UE of claim 13, wherein the type of the signal has the form of the PUCCH or the SRS, and wherein the request includes information indicating a timing advance.

16. The UE of claim 15, wherein the UE determines the timing advance based at least in part on a previously performed RACH procedure or based at least in part on a difference in downlink reception timing between a source cell and the target cell.

17. The UE of claim 15, wherein the information associated with transmitting the request indicates the timing advance.

18. The UE of claim 1, wherein the request indicates a channel or configuration associated with the activation of the CSI-RS, the IMR, the SRS, or the combination thereof.

19. A method of wireless communication performed by a user equipment (UE), comprising:
receiving information associated with transmitting a request, wherein the request is configured to trigger, on a target cell, activation of a channel state information reference signal (CSI-RS), an interference measurement resource (IMR), a sounding reference signal (SRS), or a combination thereof; and
transmitting the request to a network node associated with the target cell, wherein the request is generated based at least in part on the information associated with transmitting the request.

20. A non-transitory computer-readable medium storing a set of instructions for wireless communication, the set of instructions comprising:
one or more instructions that, when executed by one or more processors of a user equipment (UE), cause the UE to:
receive information associated with transmitting a request, wherein the request is configured to trigger, on a target cell, activation of a channel state information reference signal (CSI-RS), an interference measurement resource (IMR), a sounding reference signal (SRS), or a combination thereof; and
transmit the request to a network node associated with the target cell, wherein the request is generated based at least in part on the information associated with transmitting the request.
